(19) United States
(12) Patent Application Publication
(10) Pub. No.: US 2011/0302901 A1
(43) Pub. Date: Dec. 15, 2011

(54) ZONAL MAPPING FOR COMBUSTION OPTIMIZATION

(75) Inventors: Guang Xu, Irvine, CA (US); Neil Colin Widmer, San Clemente, CA (US)

(73) Assignee: General Electric Company, Schenectady, NY (US)

(21) Appl. No.: 12/796,765

(22) Filed: Jun. 9, 2010

(51) Int. Cl. F02C 3/00; F23N 5/00

(52) U.S. Cl. 60/39.01; 110/348; 110/186

(57) ABSTRACT

A method of optimizing operation of a furnace to control emission within a system. Each furnace zone inside of the furnace is associated with at least one exhaust zone. A signal indicative of an amount of byproduct exiting the furnace through at least one of the exhaust zones is received from one or more of the sensors. Based on this signal, an offending furnace zone is identified from among the plurality of furnace zones, the offending furnace zone including an oxygen level contributing to the amount of the byproduct. A relative adjustment of at least one of an amount of oxygen being introduced into the offending furnace zone, and an angular orientation of an oxygen injector introducing oxygen into the offending furnace zone relative to a focal region within the furnace can be initiated. The furnace may have structure to perform the method and may be part of a system.

### BACKGROUND OF THE INVENTION

1. Field of the Invention

The invention relates to a method and apparatus for controlling operation of a furnace-based-system, and specifically relates to a method and apparatus for optimizing combustion within a furnace to minimize unwanted byproduct emissions by relating a concentration of one or more unwanted byproducts exhausted through a zone of an exhaust portion of the furnace to combustion conditions in a primary zone within the furnace.

2. Discussion of Prior Art

In general, tangentially-fired (“T-fired”) boilers include a furnace in which a combination of a combustible fuel and air is combusted to generate heat for producing steam that can be used for any desired purpose such as driving a steam turbine to produce electricity for example. The combustible fuel and air are introduced into in a horizontal furnace plane within the furnace from multiple locations about the perimeter of the furnace in such a manner that the fuel and air are directed tangentially to a focal region in the furnace plane within the furnace of the boiler. The focal region is substantially concentric with the furnace, resulting in the formation of a spiraling fireball from combustion of the fuel and air mixture about the focal region within the furnace. T-fired boilers promote thorough mixing of the combustible fuel and air, stable flame conditions within the furnace of the boiler and long residence time of the combustion gases in the furnace.

Ever more stringent state and federal environmental regulations require emissions from T-fired boilers to include fewer unwanted byproducts than were previously allowed. Unwanted byproducts such as oxides of nitrogen (“NOx”), carbon monoxide (“CO”), and possibly other byproducts such as unburned carbon (commonly expressed as loss-on-ignition or “LOI”) must be kept below limits established by these regulations. Traditional boiler control systems have relied upon the monitoring of the exhaust from the furnace as a whole (i.e., the collective bulk exhaust resulting from operation of all burners operating simultaneously) to detect unacceptable levels of unwanted byproducts. A combustion anomaly was said to exist when the levels of one or more unwanted byproducts surpassed a predetermined limit for that byproduct. Based on the measured quantity of the unwanted byproduct in the collective exhaust the supply of fuel and/or air to the entire array of burners was adjusted in an attempt to operate the boiler within regulatory limits. Such control methods fail to consider the individual contribution of each burner and/or air injector to the combustion anomaly.

More recent attempts have utilized a separate sensor at the exhaust of the T-fired boiler for each individual burner and/or individual air injector. Complex computer models are required to trace the quantities of byproducts sensed from each individual sensor back to its respective individual burner and/or air injector. Developing the required computer model to perform the calculations for tracing sensed quantities back to contributions from each individual burner and/or air injector is very time consuming and expensive. Further, the computer models aimed at identifying the precise contribution of each burner and/or air injector to a quantity sensed by the respective sensor may be inaccurate due to the myriad of other contributing factors that can affect combustion and the production of unwanted byproducts. A different computer model may also be required for a boiler for various different operating conditions, requiring many different computer models to control operation of the boiler under all of the different operating conditions and adding to the complexity.

Accordingly, there is a need in the art for a method and apparatus for monitoring and controlling operation of a furnace to minimize unwanted byproduct emissions. The method and apparatus can optionally relate a byproduct quantity sensed within an exhaust zone back to a zone within a furnace that is a primary contributor to the sensed byproduct quantity.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

One aspect of the present invention provides a method of optimizing operation of a furnace within a system to control emission of an unwanted byproduct. The method includes associating each of a plurality of different furnace zones inside of the furnace with at least one exhaust zone from among a plurality of different exhaust zones through which an exhaust composition travels to exit the furnace. The method includes receiving, from at least one of a plurality of sensors in communication with each of the plurality of different exhaust zones, a signal indicative of an amount of the byproduct in the exhaust composition exiting the furnace through at least one of the exhaust zones that is in excess of a predetermined limit. The method includes identifying an offending furnace zone from among the plurality of furnace zones as a function of the signal from the at least one of the plurality of sensors. The offending furnace zone includes an oxygen level contributing to the amount of the byproduct in excess of the predetermined limit. The method includes initiating a relative adjustment of at least one of: an amount of oxygen being introduced into the offending furnace zone, and an angular orientation of an oxygen injector introducing oxygen into the offending furnace zone relative to a focal region within the furnace.

Another aspect of the present invention provides a furnace-based system. The system includes a furnace which includes a plurality of burners arranged in an array for burning a combination including a combustible fuel and oxygen within the furnace. The system includes a plurality of overfire oxygen injectors for injecting overfire oxygen into the furnace in a direction tangential to a focal region within the furnace, wherein the overfire oxygen injectors are adjustable to adjust the direction that the overfire oxygen is injected into the furnace relative to the focal region. The system includes an exhaust port for exhausting an exhaust composition from the furnace. The exhaust port includes a plurality of exhaust zones. The system includes a plurality of sensors that are operable to sense an amount of an unwanted byproduct in the exhaust composition exiting the furnace through the plurality of exhaust zones. The system includes a controller that is operable to receive signals from the plurality of sensors indicative of the amount of the unwanted byproduct in the exhaust composition exiting through at least one of the exhaust zones and to identify, based on the signals received from the plurality of sensors, a furnace zone with an oxygen level that is contributing to the amount of the unwanted byproduct sensed exiting through the at least one of the exhaust zones.

Another aspect of the present invention provides a system for generating electric power. The system includes a steam-driven turbine and a boiler for producing steam to drive the turbine. The boiler includes a furnace. The furnace includes a plurality of burners arranged in an array for burning a combination including a combustible fuel and oxygen within the furnace. The system includes a plurality of overfire oxygen injectors for injecting overfire oxygen into the furnace in a direction tangential to a focal region within the furnace, wherein the overfire oxygen injectors are adjustable to adjust the direction that the overfire oxygen is injected into the furnace relative to the focal region. The system includes an exhaust port for exhausting an exhaust composition from the furnace. The exhaust port includes a plurality of exhaust zones. The system includes a plurality of sensors that are operable to sense an amount of an unwanted byproduct in the exhaust composition exiting the furnace through the plurality of exhaust zones. The system includes a controller that is operable to receive signals from the plurality of sensors indicative of the amount of the unwanted byproduct in the exhaust composition exiting through at least one of the exhaust zones and to identify, based on the signals received from the plurality of sensors, a furnace zone with an oxygen level that is contributing to the amount of the unwanted byproduct sensed exiting through the at least one of the exhaust zones.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematic illustration of an example power generating system that includes a boiler;

FIG. 2 is a schematic side view of a furnace of the boiler shown in FIG. 1;

FIG. 3 is a cross-sectional view of the furnace shown in FIG. 2 taken along a plane indicated by line 3-3;

FIG. 4 is a cross-sectional view of the furnace shown in FIG. 2 also taken along line 3-3, similar to FIG. 3, illustrating an association between a plurality of furnace zones and a plurality of exhaust zones, wherein an arrangement of the exhaust zones is a mirror image of an arrangement of the furnace zones;

FIG. 5 is a schematic representation of a controller in communication with portions of the furnace for optimizing combustion;

FIG. 6a is a cross-sectional view of the furnace shown in FIG. 2 also taken along line 3-3, similar to FIG. 4, wherein a plurality of oxygen injectors are arranged in a base configuration;

FIG. 6b is a cross-sectional view of the furnace shown in FIG. 2 also taken along line 3-3, similar to FIG. 4, wherein one of a plurality of oxygen injectors has been adjusted relative to the base configuration shown in FIG. 6a; and

FIG. 6c is a cross-sectional view of the furnace shown in FIG. 2 also taken along line 3-3, similar to FIG. 4, wherein another of a plurality of oxygen injectors has been adjusted relative to the configuration shown in FIG. 6b.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

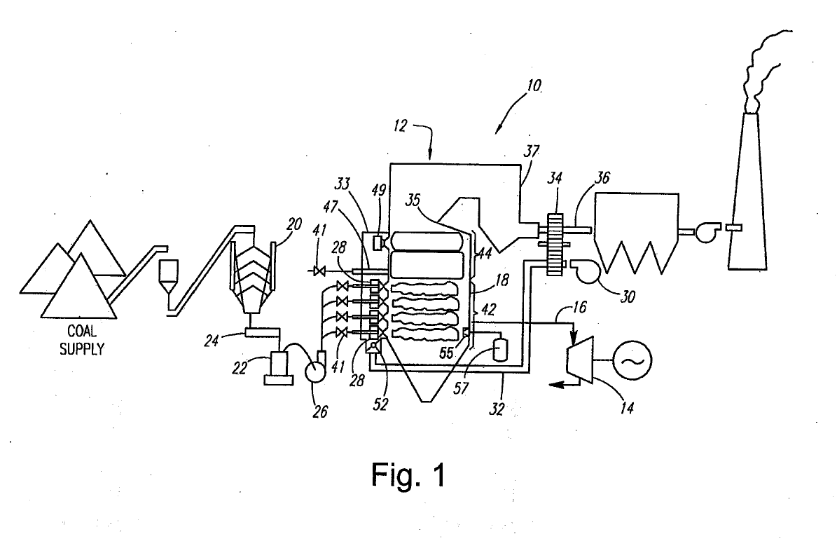

An example embodiment of a power generating system 10 is shown schematically in FIG. 1. As shown, the power generating system 10 includes, in an exemplary embodiment, a boiler 12 coupled to a steam-turbine type of generator 14. Steam produced in the boiler 12 subsequently flows through a steam pipe 16 to the generator 14, which is driven by the steam to produce electric power. The boiler 12 burns a combustible fossil fuel such as coal, or other suitable hydrocarbon fuel source, for example, in a furnace 18 to produce the heat required to convert water into steam for driving the generator 14. As such, the system can be referred to as a furnace-based system. Of course, in other embodiments the fossil fuel burned in the furnace 18 can include oil, natural gas or any other suitably combustible material. However, for the sake of brevity the description that follows will refer to coal as the fuel. Crushed coal, for example, is stored in a silo 20 and is ground or pulverized into fine particulates by a pulverizer or mill 22. A coal feeder 24 adjusts the flow of coal from the coal silo 20 into the mill 22. A forced air source such as a fan 26, for example, is used to create an airflow including entrained particulate coal from the mill 22 to convey the coal particles to furnace 18 where the coal is burned by burners 28. The air from the fan 26 used to convey the coal particles from the mill 22 to the burners 28 are referred to as primary air.

A second fan 30 supplies secondary air to the burners 28 through an air conduit 32 and a windbox 33. The secondary air is heated before being introduced into the furnace 18 upon passing through a regenerative heat exchanger 34, transferring heat from a boiler exhaust line 36 to the air conduit 32. Secondary air can optionally be introduced into the furnace 18 in addition to the primary air when there is insufficient oxygen present within the furnace 18 to allow complete combustion of the fuel being burned, a condition referred to herein as an oxygen deficiency. The secondary air is introduced into the furnace 18 in a region referred to herein as a combustion zone 42, in which the combination of the coal or other combustible fuel and oxygen from the air introduced into the furnace 18 is combusted. A region vertically above the combustion zone within the furnace 18 is utilized to supply surplus oxygen, referred to herein as overfire oxygen, to promote complete oxidation of partially oxidized byproducts such as oxide CO to fully oxidized byproducts such as CO₂, for example. This region in which overfire oxygen is introduced is referred to herein as the overfire region 44.

As shown in FIG. 1, air from the windbox 33 can be introduced into the overfire region 44 of the furnace 18 through a plurality of first oxygen injectors 47 that are fixedly coupled to the furnace 18. The oxygen injector 49 is in fluid communication with an uppermost portion of the windbox 33 to transport air from the windbox 33 into the overfire region 44. The air, and accordingly the oxygen content of the air, that is introduced into the overfire region 44 via the first oxygen injector 47 immediately above the combustion zone 42 is commonly referred to as close coupled overfire air (“CCOFA”).

A plurality of second oxygen injectors 49 can be adjustably coupled at various locations about the inner perimeter of the furnace 18, allowing the second oxygen injectors 49 to pivot relative to a focal region 60 (FIG. 3) within the furnace 18. The focal region 60 can represent a tangentially-fired (“T-fired”), spiraling fireball in the combustion zone 42 common for T-fired embodiments of the furnace 18, described in detail below. The second oxygen injector 49 can be located at various locations about the perimeter of the furnace 18 at an elevation vertically above the first oxygen injectors 47. Overfire air, and accordingly the oxygen content of the overfire air to be introduced into the furnace 18 above the CCOFA can optionally be supplied by ductwork that is separate from the windbox 33. Such overfire air supplied via ductwork separate from the windbox 33 is commonly referred to as separate overfire air (“SOFA”).

The boiler 12 also includes a network of actuators that are operable to control at least one of a process input and a boiler configuration to affect the combustion occurring within the furnace 18. The actuators can be adjusted to regulate the process inputs such as a flow rate of fuel and/or air such as the SOFA, for example, into the furnace 18. For instance, valves 41 (FIG. 1) between the fan 26 and the furnace 18 can be adjusted to regulate the supply of fuel to the burners 28, individually and/or collectively. Similarly, a damper 52 can be adjusted to regulate the flow of primary air, secondary air, CCOFA, or any combination thereof into the furnace 18. Operation of the fans 26, 30, coal feeder 24, and mill 22, alone or in any combination, can optionally be adjusted and controlled to act as the actuators and bring the operating conditions into the predetermined range of suitable values.

According to alternate embodiments, the configuration of the boiler 12 itself can be adjusted instead of, or in addition to the actuators in an attempt to bring the values of the operating conditions to within the predetermined range of suitable values. For example, the furnace 18 can optionally be provided with an additive injector 55 that penetrates a wall of the furnace 18, thereby extending into the furnace 18 for injecting a desired additive from a reservoir 57 into the furnace 18, and optionally into the primary combustion zone. A myriad of additives (such as a combustion additive, or magnesium oxide for slag) could be used, and any specifics about additives should not be considered to be a limitation upon the invention. The additive can be injected into the furnace 18. The angle at which the additive injector 55 introduces the additive into the furnace 18 can be adjusted to affect the operating conditions within the furnace 18.

The process input(s) associated with each individual burner 28 can optionally be adjusted independent of the process input(s) of other burners 28 to affect the combustion performance of the individual burners 28. Likewise, the boiler configuration, such as the injection angle of a first additive injector 55 can be adjusted independently of another additive injector (not shown). This independent adjustment of the boiler configuration can primarily affect the combustion performance of a burner 28 adjacent to the first additive injector 55 without significantly affecting the combustion performance of another burner 28 spatially separated from the first additive injector 55. Thus, the combustion performance of each of the burners 28 can be adjusted and corrected individually to promote substantially-balanced combustion.

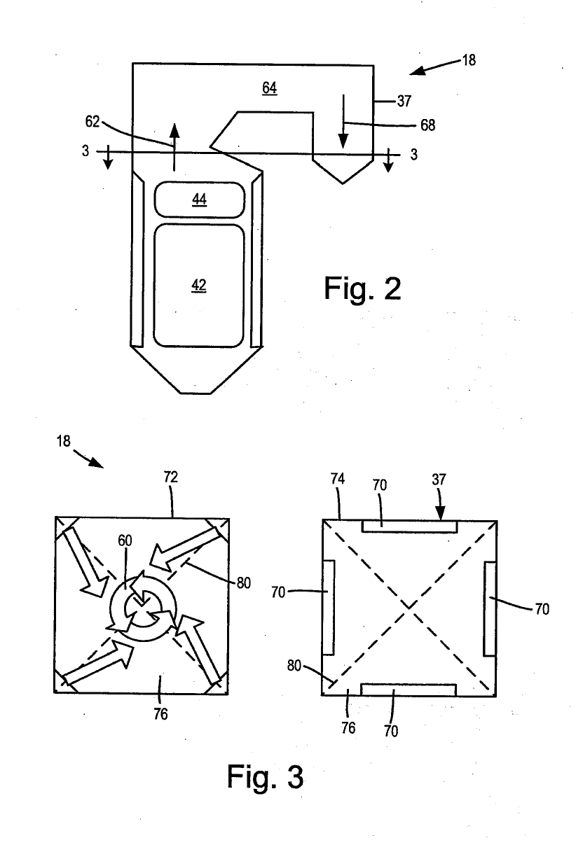

A flue gas including gaseous combustion products such as fully combusted fuel in the form of CO2, in addition to undesirable byproducts such as NOx and CO compositions, for example, travels in a substantially vertical direction upward within the furnace 18. The flue gas travels upward beyond a nose 35 that protrudes into an interior chamber defined by the furnace 18, and then generally vertically downward through an exhaust port 37 leading to the exhaust line 36. The exhaust port 37 is said to be “downstream” of the burners 28 as the flue gas travels from the combustion zone 42 and overfire region 44 to the exhaust port 37. As shown in FIG. 2, the bulk flow direction of flue gasses departing the combustion zone 42 can be substantially vertical in a direction indicated by arrow 62. The flue gasses are exposed to one or both of the CCOFA and SOFA within the overfire region 44, where the flue gasses can become at least partially oxidized, before passing beyond the nose 35 and then through a horizontal passage 64. The at least partially oxidized flue gas, having been exposed to one or both of the CCOFA and SOFA, being exhausted from the boiler 12 is referred to herein as an exhaust gas. The bulk flow direction of the exhaust gas can optionally travel in a substantially-vertical downward direction, parallel to a longitudinal axis of the exhaust port 37 of the furnace 18, as indicated by arrow 68.

FIG. 3 is a sectional view taken along line 3-3 in FIG. 2 looking down into the overfire region 44 of a T-fired embodiment of the furnace 18 and into the exhaust port 37. The combustible fuel and air are introduced into the combustion zone 42 (FIGS. 1 and 2) from multiple locations about the perimeter of the furnace 18 in such a manner that the fuel and air are directed tangentially to the focal region 60, representing the spiraling fireball within the furnace 18. The focal region 60 is substantially concentric with the combustion zone 42 (FIGS. 1 and 2) of the furnace 18, resulting in the formation of the spiraling fireball from combustion of the fuel and air mixture.

A furnace plane 72 portion of the furnace 18 shown in FIG. 3 can be a plane within the overfire region 44 of the furnace 18 that is substantially perpendicular to the bulk flow direction of the flue gasses represented by arrow 62 in FIG. 2. Likewise, FIG. 3 shows an exhaust plane 74, which can be a plane substantially perpendicular to the bulk flow direction of the exhaust gasses traveling through the exhaust port 37. The furnace plane 72 can be divided into a plurality or furnace zones 76 and the exhaust plane 74 can be divided into a plurality of exhaust zones 78. The furnace zones 76 and exhaust zones 78 are indicated in FIG. 3 by broken zone lines 80. The furnace and exhaust zones 76, 78 are logical zones that are separated by imaginary partitions for the purpose of mapping combustion anomalies as described in detail below. In other words, the broken lines 80 separating the furnace and exhaust zones 76, 78 are not physical partitions. Further, although four triangular furnace and exhaust zones 76, 78 are shown, the furnace plane 72 and the exhaust plane 74 can optionally be broken into at least two, or optionally any desired number for the particular control application.

With continued reference to FIG. 3, the arrows appearing in the furnace plane 72 represent a direction in which each of the second oxygen injectors 79 placed in the comers of the furnace 18 are oriented relative to the focal region 60. The second oxygen injectors 79 are pivotal in the furnace plane 72 relative to the focal region 60 to supply SOFA as needed in oxygen-depleted regions within the furnace plane 72 as described in detail below. Further, the flow rate of SOFA into the overfire region 44 (FIGS. 1 and 2) can be adjustable instead of, or in addition to the pivotal adjustment of the second oxygen injectors 79 for ensuring sufficient oxygen levels to minimize exhausting of unwanted byproducts such as CO.

A plurality of sensors 70 can be positioned at various locations adjacent to the exhaust port 37 for sensing an amount of the byproduct in the exhaust gasses exiting the furnace 18 through at least one of the exhaust zones 78 that is in excess of a predetermined limit. For example, the sensors 70 can be operable to sense an amount of CO, or a concentration of CO within the exhaust gasses exiting the furnace 18 through each of the exhaust zones 78. In the illustrative embodiments described herein the sensors 70 are operable to sense an amount or concentration of CO, and can sense when the amount or concentration of CO exceeds a predetermined upper limit deemed acceptable to be discharged from the furnace 18. However, alternate embodiments can optionally utilize sensors 70 operable to sense any operating parameter such as temperature, pressure, or the amount or concentration of any other byproduct included in the exhaust gasses exiting the furnace 18 through the exhaust port 37. However, for the sake of brevity the examples discussed below include a CO sensor 70 for sensing an amount of CO included in the exhaust gasses.

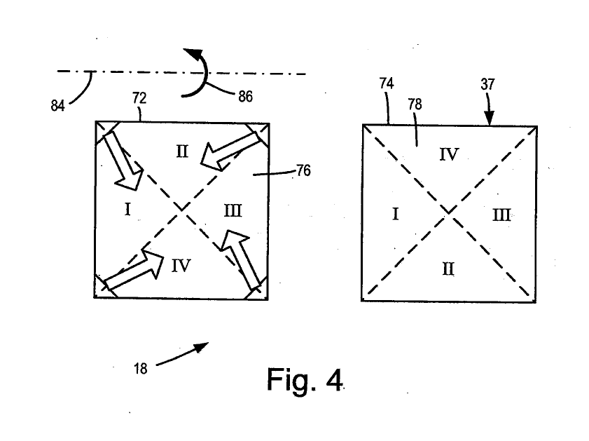

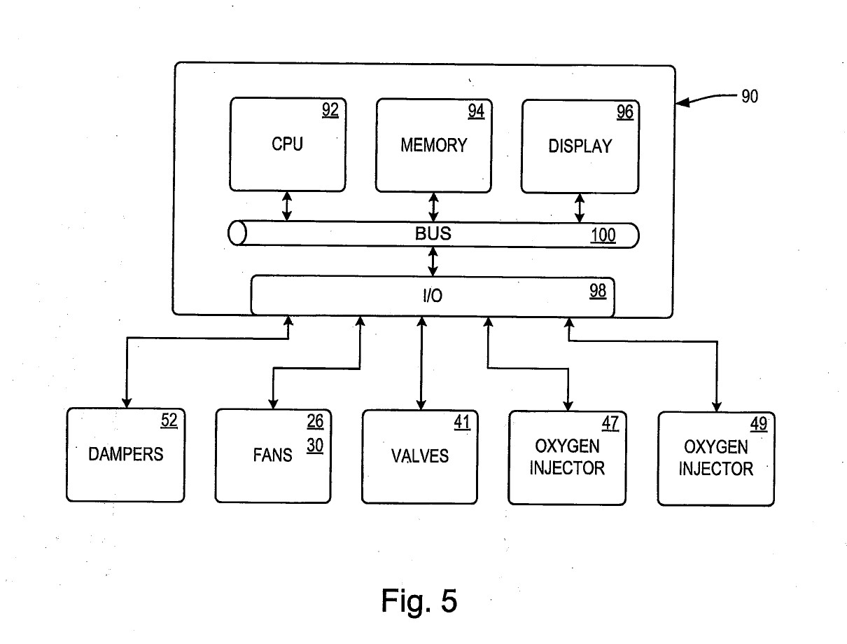

FIG. 4 shows an example of an association between exhaust zones 78 and furnace zones 76 utilized by a controller 90 (FIG. 5) as described in detail below. In FIG. 4 the four furnace and exhaust zones 76, 78 are labeled with Roman Numerals I-IV. An exhaust zone 78 labeled with the same Roman Numeral as one of the furnace zones 76 is said to be associated with that furnace zone 76. For the example shown in FIG. 4, the arrangement of exhaust zones 78 in the exhaust plane 74 is a mirror image of the arrangement of furnace zones 76 in the furnace plane 72 as if reflected over the line 84 in the direction of arrow 86. Thus, the arrangement of furnace zones I and III is the same as the arrangement of exhaust zones I and III. However, the arrangement of furnace zones II and IV is the opposite of the arrangement of exhaust zones II and IV.

Sensed amounts of CO above a predetermined upper limit within one or more of the exhaust zones 78 is indicative of an oxygen depletion in the corresponding furnace zone(s) 76. Referring once again to the embodiment shown in FIG. 4, an excess amount of CO sensed in exhaust zone I is indicative of an oxygen depletion condition within furnace zone I. The same is true of exhaust and furnace zones IV. An excessive amount of CO sensed by sensors 70 in exhaust zone IV is indicative of an oxygen depletion condition in furnace zone IV. The association between the CO levels in each exhaust zone 78 and the oxygen levels in one or more of the furnace zones 76 is established by a model representing the path along which flue gasses from the combustion zone 42 (FIG. 2), travel through the overfire region 44 and furnace plane 72, and eventually exit the furnace 18 through the exhaust plane 74 in the exhaust port 37. A different model can be programmed as computer-readable instructions and parameters into the controller 90 (FIG. 5) to be used to relate a sensed excess of CO in one or more of the exhaust zones 78 to an oxygen level in one or more of the furnace zones 76 as described below.

FIG. 5 shows an example of a controller 90 that can be operatively connected to communicate with various controllable portions of the furnace 18 to associate a sensed CO level in one or more of the exhaust zones 78 to an oxygen level in one or more of the furnace zones 76. As shown, the controller 90 includes a processor 92 that can be a programmable microprocessor, for example, in communication with a computer-readable memory 94. The. computer-readable memory 94 is shown separate from the processor 92, but can optionally be implemented as an embedded electronically erasable and programmable read only memory (“EEPROM”) commonly integrated into programmable microprocessors as part of an embedded system. The controller 90 can optionally include a display device 96 for displaying the results of control operations to a technician who is to manually adjust operation of the furnace to supply each furnace zone 76 with sufficient amounts of oxygen. According to alternate embodiments, the controller 90 can transmit control signals to automatically (i.e., without intervention from a technician) initiate adjustments of the operating parameters of the furnace 18 as described below. For such embodiments, the display device 96 can optionally display a status of the furnace 18, as adjusted. Signals between the processor 92 and the portions of the furnace 18 such as the dampers 52, fans 26 and 30, valves 41, and the first and second oxygen injectors 47, 49 can be transmitted via any suitable input/output interface 98, and delivered by a conventional BUS system 100.

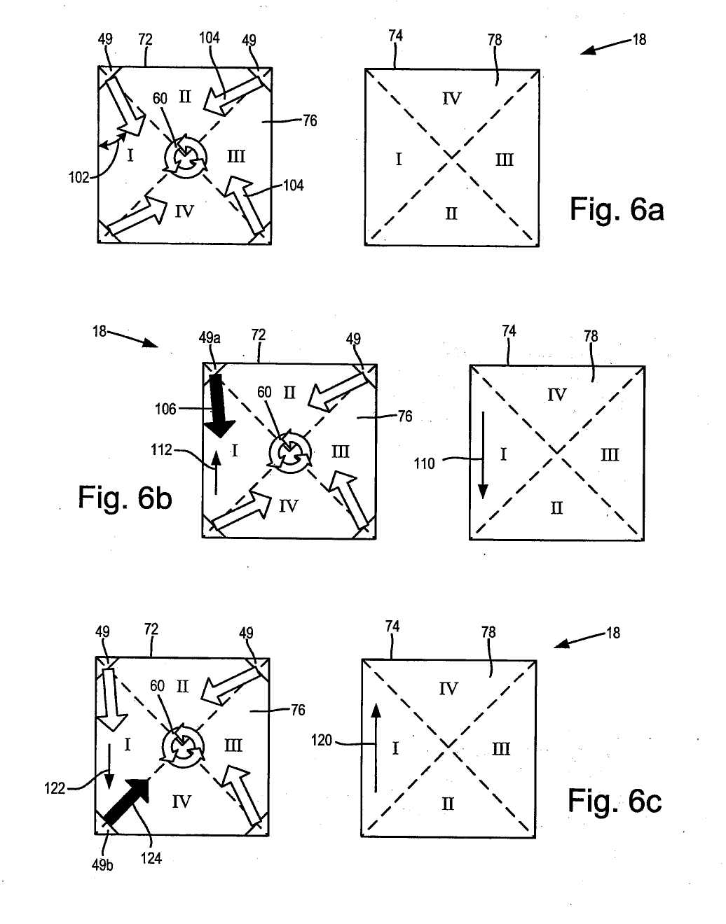

An example of a method of optimizing operation of a boiler to control emission of an unwanted byproduct is described with reference to FIGS. 6a-6c. Again, the method is described as controlling an oxygen level in a furnace zone 76 in response to detecting an excess amount of CO in one or more of the exhaust zones 78. However, as previously explained the method can be performed to control any parameter in one or more of the furnace zones 76 based on a sensed parameter in one or more of the exhaust zones 78. Further, the cross sections of the furnace 18 shown in FIGS. 6a -6c show four of the adjustable second oxygen injectors 49, one at each corner within the furnace 18. But again, this furnace 18 configuration is merely illustrative, and can vary without departing from the scope of the present invention.

In general, the controller 90 (FIG. 5) includes a plurality of computer models stored in the computer-readable memory 94 (FIG. 5) associating each of the plurality of different furnace zones 76 with at least one of the exhaust zone 78. At least one of a plurality of sensors 70 (FIG. 5) provided to monitor the CO levels in the plurality of exhaust zones 78 transmits a signal indicative of an amount of the CO in the exhaust gas that is in excess of a predetermined limit. The predetermined limit can possibly be an uppermost concentration level or quantity established by environmental regulations, for example, or a value within an acceptable safety margin of such a limit. Based on the signal from at least one of the plurality of sensors 70, the controller 90 identifies the offending furnace zone 76 from among the other furnace zones 76 that is a primary contributor to the excess quantity of CO sensed by one or more of the sensors 70. The offending furnace zone 76 is considered to have an oxygen level insufficient for complete oxidation of the CO to CO2 to occur, and thus, is considered to be a contributing factor for the amount of the CO sensed in excess of the predetermined upper limit. In response to identifying the offending furnace zone 76, the controller 90 (FIG. 5) can initiate a relative adjustment of the an amount of SOFA being introduced within the overfire region 44 (FIGS. 1 and 2) for the offending furnace zone 76, the angular orientation of the second oxygen injector(s) 49 introducing the SOFA for the offending furnace zone 76 relative to the focal region 60, or both.

FIGS. 6a-6c also illustrates the relative adjustment of the angular orientation of the second oxygen injector(s) 49 during optimization of boiler operation. The adjustment of the angular orientation of the second oxygen injector(s) in the direction of arrow 102 in FIG. 6a and optionally in the furnace plane 72, the flow rate of oxygen into the overfire region 44 (FIGS. 1 and 2) from one or more of the second oxygen injectors 49, or both is relative to those parameters as they existed immediately before the adjustment initiated by the controller. The relative adjustment is thus initiated relative to the existing angular orientation and flow rate parameters affecting a property in an offending furnace zone 76 associated with an exhaust zone 78. Thus, the relative adjustments are performed on the basis of a sensed value in an exhaust zone 78 associated with the offending furnace zone 76. This is contrasted with the complex method of pinpointing a specific burner 28 (FIG. 1), for example, and calculating a quantitative operating parameter for each specific burner 28 based on a sensed value of an exhaust gas.

FIG. 6a will be described as the starting configuration of the furnace 18. In this configuration, each of the second oxygen injectors 49 introducing the SOFA into the furnace 18 has an angular orientation (indicated by arrows 104) to tangentially supply the SOFA to the focal region 60. In FIG. 6b, however, one or more of the sensors 70 (FIG. 3) senses an excess amount of CO within the exhaust gas exiting through a portion of exhaust zone I, for example. The sensors 70 can optionally indicate a direction in which the CO concentration is increasing, thereby indicating a direction in which any excess oxygen in the corresponding furnace zone I is shifting. For the example shown in FIG. 6b, the CO amounts are sensed to be increasing in the direction of arrow 110, indicating that the flow of oxygen within furnace zone I is shifting (i.e., the oxygen amounts are increasing) in the direction of arrow 112.

To counter the flow of oxygen within furnace zone I and promote substantially-uniform oxidation of CO across the furnace plane 72, the sensor(s) 70 transmit a signal indicative of this sensed condition to be received by the controller 90 (FIG. 5). In response to receiving the signal, the controller 90 associates the sensed condition indicated by the signal, based on the computer models programmed into the controller 90, with furnace zone I as having an oxygen level in a portion thereof that is insufficient to promote oxidation of the CO rising from the combustion zone 42 (FIG. 2) into CO2. The controller 90 then adjusts the angular orientation of the second oxygen injectors 49a relative to the focal region 60 to direct the SOFA in a direction indicated by shaded arrow 106 and counter the direction of oxygen migration indicated by arrow 112. Shaded arrows are used in FIGS. 6b and 6c to indicate current adjustments of the angular orientation of a second oxygen injector 49 in that illustrated step. The flow rate of SOFA introduced into the furnace 18 via the second oxygen injector 49a, or any of the other second oxygen injectors 49 can also be adjusted.

According to alternate embodiments, the adjustment described above as being initiated by the controller 90 can optionally be displayed via the display 88 (FIG. 5) to be manually initiated by a technician instead of automatically initiated by the controller 90.

The furnace 18 continues to operate and an excess amount of CO exiting through exhaust zone I is again sensed. In this instance, however, the amount of CO is now increasing within exhaust zone I in the direction of arrow 120 as shown in FIG. 6c, suggesting that the oxygen within furnace zone I is migrating in the direction of arrow 122. Again, a signal from the sensor(s) 70 (FIG. 3) is received by the controller 90 (FIG. 5) which, in turn, initiates adjustment of at least one of the angular orientation and the SOFA flow rate of the second oxygen injector 49b. Again, the angular orientation of the second oxygen injector 49b adjusted in the step illustrated in FIG. 6c is indicated by the shaded arrow 124.

Similar adjustments continue to occur during operation of the furnace 18, and for each of the furnace and exhaust zones 76, 78 to ensure a substantially uniform distribution of oxygen within the overfire region 44 disposed vertically above the combustion zone 42 (FIG. 2). The substantially-uniform oxygen levels throughout the furnace plane 72 promotes complete oxidation of CO into CO2, and minimizes the amount of unwanted CO byproduct that exits the furnace 18 via the exhaust port 37.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A method of optimizing operation of a furnace within a system to control emission of an unwanted byproduct, the method including:
associating each of a plurality of different furnace zones inside of the furnace with at least one exhaust zone from among a plurality of different exhaust zones through which an exhaust composition travels to exit the furnace;
receiving, from at least one of a plurality of sensors in communication with each of the plurality of different exhaust zones, a signal indicative of an amount of the byproduct in the exhaust composition exiting the furnace through at least one of the exhaust zones that is in excess of a predetermined limit;
identifying an offending furnace zone from among the plurality of furnace zones as a function of the signal from the at least one of the plurality of sensors, the offending furnace zone including an oxygen level contributing to the amount of the byproduct in excess of the predetermined limit; and
initiating a relative adjustment of at least one of: an amount of oxygen being introduced into the offending furnace zone, and an angular orientation of an oxygen injector introducing oxygen into the offending furnace zone relative to a focal region within the furnace.

2. The method according to claim 1, wherein said receiving includes receiving a signal from each of the sensors indicative of an amount of the byproduct in the exhaust composition traveling through each of the exhaust zones in a common exhaust plane adjacent to an exhaust port of the furnace.

3. The method according to claim 1, wherein:
the furnace zones are located within a common furnace plane inside the furnace, the common furnace plane being substantially perpendicular to a bulk flow direction of flue gasses within the furnace;
the plurality of exhaust zones are located within a common exhaust plane adjacent to an exhaust port of the furnace, the common exhaust plane being substantially perpendicular to a bulk flow direction of the exhaust composition;
an arrangement of the exhaust zones within the common exhaust plane is substantially a mirror image of the furnace zones within the common furnace plane, and further wherein
said identifying the offending furnace zone includes selecting a mirror image counterpart of the at least one of the exhaust zones in which the amount of the byproduct in the exhaust composition is in excess of the predetermined limit.

4. The method according to claim 1, wherein said associating each of the plurality of different furnace zones with the at least one exhaust zone includes associating a mirror image counterpart of a plurality of the exhaust zones with a plurality of the furnace zones.

5. The method according to claim 1, wherein said initiating the relative adjustment includes initiating adjustment of the amount of oxygen being introduced into the offending furnace zone and the angular orientation of an oxygen injector relative to a result of a previous adjustment.

6. A furnace-based system including:
a furnace including a plurality of burners arranged in an array for burning a combination including a combustible fuel and oxygen within the furnace;
a plurality of overfire oxygen injectors for injecting overfire oxygen into the furnace in a direction tangential to a focal region within the furnace, wherein the overfire oxygen injectors are adjustable to adjust the direction that the overfire oxygen is injected into the furnace relative to the focal region;
an exhaust port for exhausting an exhaust composition from the furnace, the exhaust port including a plurality of exhaust zones;
a plurality of sensors that are operable to sense an amount of an unwanted byproduct in the exhaust composition exiting the furnace through the plurality of exhaust zones; and
a controller that is operable to receive signals from the plurality of sensors indicative of the amount of the unwanted byproduct in the exhaust composition exiting through at least one of the exhaust zones and to identify, based on the signals received from the plurality of sensors, a furnace zone with an oxygen level that is contributing to the amount of the unwanted byproduct sensed exiting through the at least one of the exhaust zones.

7. The system according to claim 6, wherein the furnace zone identified by the controller is among a plurality of furnace zones located within a common furnace plane at an elevation inside the furnace vertically above a combustion zone and adjacent to the overfire oxygen injectors.

8. The system according to claim 7, wherein the furnace plane is substantially perpendicular to a bulk flow direction of flue gasses rising from the combustion zone within the furnace.

9. The system according to claim 8, wherein the furnace plane includes at least four furnace zones.

10. The system according to claim 6, wherein the plurality of exhaust zones are arranged in a common exhaust plane adjacent to an exhaust port of the furnace.

11. The system according to claim 10, wherein the common exhaust plane is substantially perpendicular to a bulk flow direction of the exhaust composition.

12. The system according to claim 6, wherein:
the furnace zones are located within a common furnace plane inside the furnace, the common furnace plane being substantially perpendicular to a bulk flow direction of flue gasses within the furnace;
the plurality of exhaust zones are located within a common exhaust plane adjacent to the exhaust port of the furnace, the common exhaust plane being substantially perpendicular to a bulk flow direction of the exhaust composition; and
an arrangement of the exhaust zones within the common exhaust plane is substantially a mirror image of an arrangement of the furnace zones within the common furnace plane.

13. The system according to claim 6, wherein the plurality of sensors are operable to sense an amount of CO in the exhaust composition and the controller is operable to relate the amount of CO in the exhaust composition to an oxygen deficiency in at least one of the furnace zones.

14. A system for generating electric power including:
a steam-driven turbine; and
a boiler for producing steam to drive the turbine and including a furnace, the furnace including a plurality of burners arranged in an array for burning a combination including a combustible fuel and oxygen within the furnace;
a plurality of overfire oxygen injectors for injecting overfire oxygen into the furnace in a direction tangential to a focal region within the furnace, wherein the overfire oxygen injectors are adjustable to adjust the direction that the overfire oxygen is injected into the furnace relative to the focal region;
an exhaust port for exhausting an exhaust composition from the furnace, the exhaust port including a plurality of exhaust zones;
a plurality of sensors that are operable to sense an amount of an unwanted byproduct in the exhaust composition exiting the furnace through the plurality of exhaust zones; and
a controller that is operable to receive signals from the plurality of sensors indicative of the amount of the unwanted byproduct in the exhaust composition exiting through at least one of the exhaust zones and to identify, based on the signals received from the plurality of sensors, a furnace zone with an oxygen level that is contributing to the amount of the unwanted byproduct sensed exiting through the at least one of the exhaust zones.
